(19) United States
(12) Patent Application Publication
(10) Pub. No.: US 2017/0177708 A1
(43) Pub. Date: Jun. 22, 2017

(54) TERM WEIGHT OPTIMIZATION FOR CONTENT-BASED RECOMMENDER SYSTEMS

(71) Applicant: LinkedIn Corporation, Mountain View, CA (US)

(72) Inventors: Bo Zhao, Redwood City, CA (US); Yupeng Gu, Boston, MA (US); David Hardtke, Oakland, CA (US)

(21) Appl. No.: 15/055,295

(22) Filed: Feb. 26, 2016

Related U.S. Application Data
(60) Provisional application No. 62/268,996, filed on Dec. 17, 2015.

(51) Int. Cl. G06F 17/30; G06Q 10/10; G06N 99/00

(52) U.S. Cl. CPC G06F 17/30675; G06N 99/005; G06Q 10/1053

(57) ABSTRACT

A system, a machine-readable storage medium storing instructions, and a computer-implemented method are described herein are directed to a Term Weight Engine that defines a pairing comprising a user profile text section paired with a job post text section. The Term Weight Engine learns a pairing weight indicating an extent that a similarity of text in the pairing predicts a relevance of a respective job posting to a given user profile. The Term Weight Engine learns a global weight for a term(s). The Term Weight Engine calculates a similarity score of the pairing as between a first user profile of a target member account and a first job posting. Based on identifying the term appears in the pairing as between a first user profile of a target member account and a first job posting, the Term Weight Engine applies the global weight to the similarity score to generate a prediction indicating whether the target member account will apply to the first job posting. The Term Weight Engine determines whether to send a recommendation

### CROSS-REFERENCE TO RELATED APPLICATIONS

This application claims the benefit of priority to U.S. Provisional Patent Application entitled “Term Weight Optimization for Content-Based Recommender Systems,” Ser. No. 62/268,996, filed Dec. 17, 2015, which is hereby incorporated herein by reference in its entirety.

### TECHNICAL FIELD

The present disclosure generally relates to data processing systems. More specifically, the present disclosure relates to methods, systems and computer program products for sending recommendations in a social network.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram illustrating a client-server system, in accordance with some examples of the present disclosure;

FIG. 2 is a block diagram showing functional components of a professional social network within a networked system, in accordance with some examples of the present disclosure

FIG. 3 is a block diagram showing example components of a Term Weight Engine, according to some examples of the present disclosure

FIG. 4 is a flowchart illustrating a method of determining whether to recommend a job posting to a target member account, according to some examples of the present disclosure.

FIG. 5 is a block diagram illustrating text section pairings, pairing weights, global terms and global term weights, according to embodiments described herein.

FIG. 6 is a block diagram illustrating text sections of a target member account's profile and text sections of a job posting, according to embodiments described herein.

FIG. 7 is a block diagram illustrating generating a prediction of whether a target member account will apply to given job posting, according to embodiments described herein.

FIG. 8 is a block diagram of an example computer system on which methodologies described herein may be executed, in accordance with some examples of the present disclosure.

### DETAILED DESCRIPTION

The present disclosure describes methods and systems for sending a recommendation to a target member account(s) in a social network (or “professional social network”). In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

In conventional systems, a term that appears frequently throughout a document corpus is treated as being less important than a term that appears less frequently. In contrast to conventional systems, the Term Weight Engine predicts the actions a given member account will take with respect to a particular job posting based on whether the given member account's profile and the job posting have similar text sections and whether a global term(s) is present in the given member account's profile or the job posting. In some embodiments, while a global term may appear in a particular job posting and frequently appear throughout all job postings on a social network service, it can still be highly predictive of whether a given member account will apply to the particular job posting due to its learned global weight coefficient.

The Term Weight Engine learns weights for certain pairings of user profile text sections and job posting sections. Presence of threshold text similarities between such paired text sections are predictive of whether a given member account will (or will not) apply to a particular job posting. In addition, the Term Weight Engine learns a global weight (GW) for a particular global term(s) when it appears in a particular text section of a user profile and/or a job posting. Presence of a global term(s)—in a user profile or job posting—is further predictive of the whether or not a given member account will apply to a particular job posting.

A system, a machine-readable storage medium storing instructions, and a computer-implemented method as described herein are directed to a Term Weight Engine. The Term Weight Engine defines a pairing comprising a user profile text section paired with a job post text section. The Term Weight Engine learns a pairing weight indicating an extent that a similarity of text in the pairing predicts a relevance of a respective job posting to a given user profile. The Term Weight Engine learns a global weight for a term(s). The Term Weight Engine calculates a similarity score of the pairing as between a first user profile of a target member account and a first job posting. Based on identifying that the term appears in the pairing as between a first user profile of a target member account and a first job posting, the Term Weight Engine applies the global weight to the similarity score to generate a prediction indicating whether the target member account will apply to the first job posting. The Term Weight Engine determines whether to send a recommendation of the first job posting to the target member account based on the prediction. It is understood that various embodiments of the Term Weight Engine use logistic regression techniques to learn pairing weights and global weights.

In various embodiments, the Term Weight Engine learns a global weight for appearance of a term(s) in a particular job post section based on previous interactions (i.e. clicks, views, ratings, actions) of a plurality of member accounts with respective job postings that include the term(s) in the particular job post text section.

In various embodiments, the Term Weight Engine learns a global weight of a term(s) in a particular user profile section based on previous interactions of a plurality of member accounts with respective job postings, wherein the plurality of member accounts have corresponding user profiles that include the term(s) in the particular user profile text section.

In various embodiments, the Term Weight Engine calculates a similarity score of a pairing as between a first user profile and a first job posting by applying a cosine similarity function to a given user profile text section of a first user profile and a given job post text section of the first job posting, wherein the given user profile text section and the given job post text section are pre-defined as being paired together according to a machine learning model.

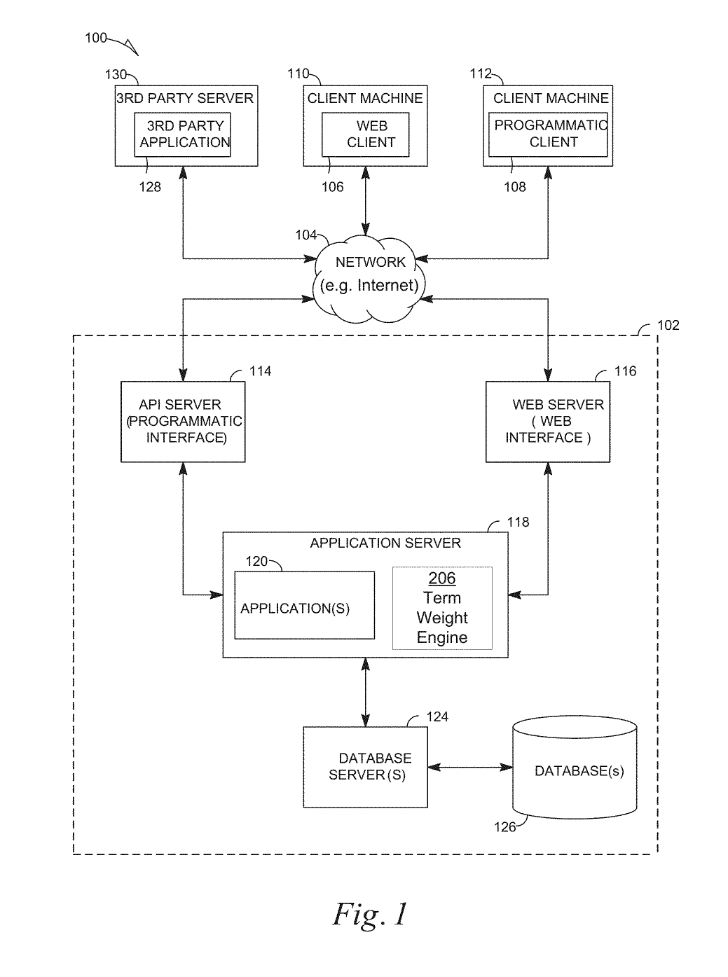

FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102. In another embodiment, the Term Weight Engine 206 as described herein can be executed by one or more of the application servers 118.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102. In some embodiments, the networked system 102 may comprise functional components of a professional social network.

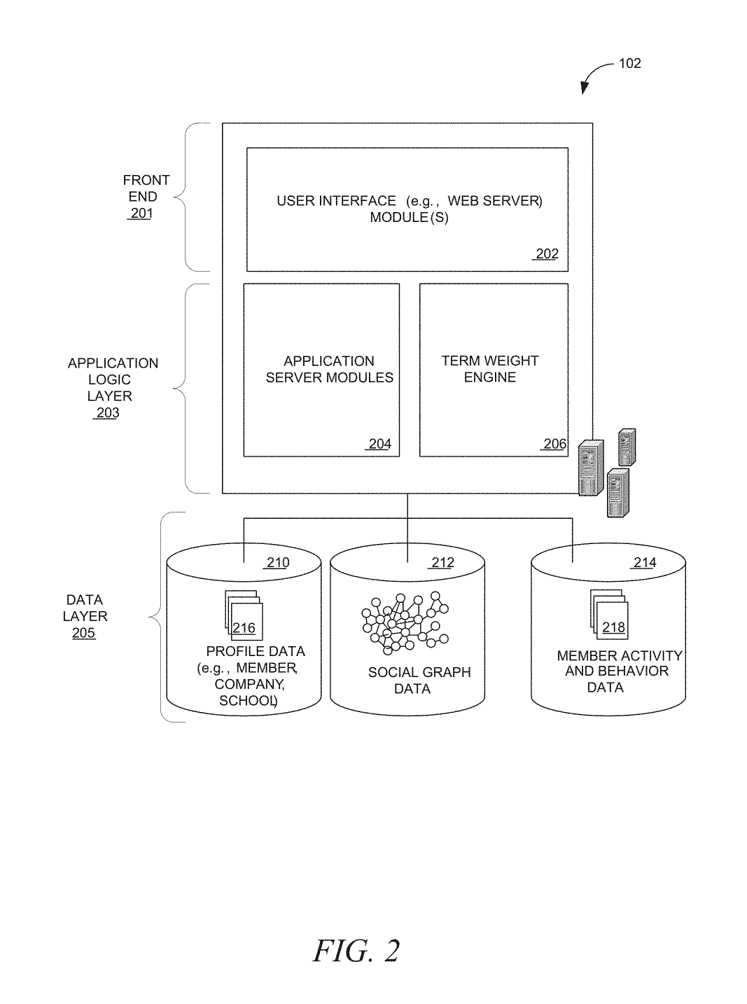

FIG. 2 is a block diagram showing functional components of a professional social network within the networked system 102, in accordance with an example embodiment.

As shown in FIG. 2, the professional social network may be based on a three-tiered architecture, consisting of a front-end layer 201, an application logic layer 203, and a data layer 205. In some embodiments, the modules, systems, and/or engines shown in FIG. 2 represent a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 2. However, one skilled in the art will readily recognize that various additional functional modules and engines may be used with a professional social network, such as that illustrated in FIG. 2, to facilitate additional functionality that is not specifically described herein. Furthermore, the various functional modules and engines depicted in FIG. 2 may reside on a single server computer, or may be distributed across several server computers in various arrangements. Moreover, although a professional social network is depicted in FIG. 2 as a three-tiered architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface module(s) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface module(s) 202, generates various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. The profile data 216 also includes attribute data of one or more job postings (or job listings). Consistent with some embodiments, when a person initially registers to become a member of the professional social network, the person will be prompted to provide some profile attribute data such as, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization with the professional social network the representative may be prompted to provide certain information about the organization. This information may be stored, for example, in the database 210, or another database (not shown). With some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. With some embodiments, importing or otherwise accessing data from one or more externally hosted data sources may enhance profile data 216 for both members and organizations. For instance, with companies in particular, financial data may be imported from one or more external data sources, and made part of a company's profile.

The profile data 216 may also include information regarding settings for members of the professional social network. These settings may comprise various categories, including, but not limited to, privacy and communications. Each category may have its own set of settings that a member may control.

Once registered, a member may invite other members, or be invited by other members, to connect via the professional social network. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, with some embodiments, the professional social network may include a photo sharing application that allows members to upload and share photos with other members. With some embodiments, members may be able to self-organize into groups, or interest groups, organized around a subject matter or topic of interest. With some embodiments, the professional social network may host various job listings providing details of job openings with various organizations.

As members interact with the various applications, services and content made available via the professional social network, the members' behaviour (e.g., content viewed, links or member-interest buttons selected, etc.) may be monitored and information 218 concerning the member's activities and behaviour may be stored, for example, as indicated in FIG. 2, by the database 214. This information 218 may be used to classify the member as being in various categories and may be further considered as an attribute of the member. For example, if the member performs frequent searches, views and applies to job posting, thereby exhibiting behaviour indicating that the member is a likely job seeker, this information 218 can be used to classify the member as being a job seeker and further be used to predict whether the member will apply to other similar job postings. This classification can then be used as a member profile attribute for purposes of enabling others to target the member for receiving messages, status updates and/or a list of ranked premium and recommending job postings. It is understood that at least a portion of the information 218 can be used as training data in order learn text section pairing, global terms, pairing weight and global weights as described herein.

In some embodiments, the professional social network provides an application programming interface (API) module via which third-party applications can access various services and data provided by the professional social network. For example, using an API, a third-party application may provide a user interface and logic that enables an authorized representative of an organization to publish messages from a third-party application to a content hosting platform of the professional social network that facilitates presentation of activity or content streams maintained and presented by the professional social network. Such third-party applications may be browser-based applications, or may be operating system-specific. In particular, some third-party applications may reside and execute on one or more mobile devices (e.g., a smartphone, or tablet computing devices) having a mobile operating system.

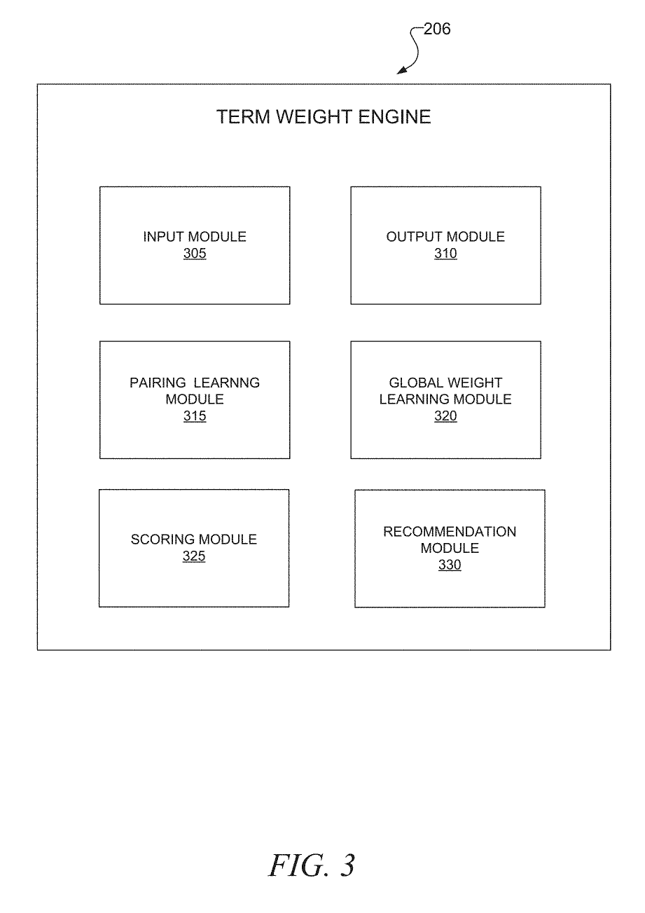

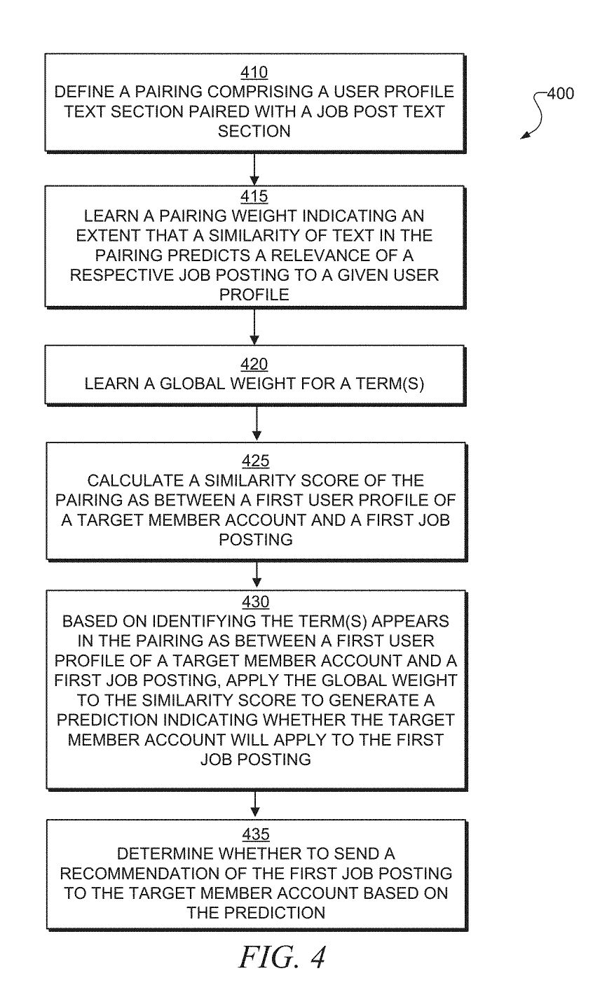

The data in the data layer 205 may be accessed, used, and adjusted by the Term Weight Engine 206 as will be described in more detail below in conjunction with FIGS. 3-4. Although the Term Weight Engine 206 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure.

FIG. 3 is a block diagram showing example components of a Term Weight Engine 206, according to some embodiments.

The input module 305 is a hardware-implemented module that controls, manages and stores information related to any inputs from one or more components of system 102 as illustrated in FIG. 1 and FIG. 2. In various embodiments, the inputs include various interactions of a plurality of member accounts with respective job postings. Inputs further include one or more pre-defined text sections of user profiles and job postings.

The output module 310 is a hardware-implemented module that controls, manages and stores information related to sending outputs to one or more components of system 100 of FIG. 1 (e.g., one or more client devices 110, 112, third party server 130, etc.). In some embodiments, the output is a notification recommending a job posting to a target member account(s), a graphical user interface (GUI) with such notification, or an alert representative of the notification displayed within a GUI.

The pairing learning module 315 is a hardware implemented module which manages, controls, stores, and accesses information related to defining pairings comprising at least one user profile text section and at least one job posting text section. The pairing learning module 315 further learns a pairing weight, for each pairing, based on previous interactions of a plurality of member accounts with respective job postings.

The global weight learning module 320 is a hardware-implemented module which manages, controls, stores, and accesses information related to learning a section-specific global weight for a term(s). The global weight learning module 320 learns the section-specific global weight for a term(s) based on previous interactions of a plurality of member accounts with respective job postings.

The scoring module 325 is a hardware-implemented module which manages, controls, stores, and accesses information related to generating a prompt for display on a client device related to calculating a similarity score between a given user profile of a target member account and a respective job posting. The scoring module 325 scores the similarity of pairings of text sections as between the given user profile and the respective job posting. The scoring module 325 applies the corresponding pairing weights and section-specific global weights to generate a prediction as to whether the target member account will apply to the respective job posting.

The recommendation module 330 is a hardware-implemented module which manages, controls, stores, and accesses information related to sending a recommendation of a job posting to a target member account(s).

FIG. 4 is a flowchart illustrating a method 400 of determining whether to recommend a job posting to a target member account, according to embodiments described herein.

At operation 410, the Term Weight Engine 206 defines a pairing comprising a user profile text section paired with a job post text section. For example, a first pairing is a user profile “Skills” section and a job posting “Skills” section. A second pairing is a user profile “Job Description” section and a job posting “Skills” section. A third pairing is a user profile “Skills” section and a job posting “Job Description” section.

At operation 415, the Term Weight Engine 206 learns a pairing weight indicating an extent that a similarity of text in the pairing predicts a relevance of a respective job posting to a given user profile. For example, based on previous interactions between a plurality of member accounts and various job postings, the Term Weight Engine 206 learns and generates a pairing weight for each pairing. As such, the first pairing is assigned a first pairing weight, the second pairing is assigned a second pairing weight and the third pairing is assigned a third pairing weight. It is understood that the first, second and third pairing weights can be different than each other.

A pairing weight represents a learned coefficient reflective of a degree to which a similarity in a pairing (i.e. a similarity between text of a user profile “Skills” section and text of a job posting “Skills” section) predicts whether a member account will apply to a job posting. Stated differently, a particular pairing may have a very low pairing weight if the Term Weight Engine 206 learns that various member accounts did not apply to a job posting even though there was a high degree of similarity in the particular pairing's text sections as between those member accounts and that job posting.

At operation 420, the Term Weight Engine 206 learns a global weight for at least one term. For example, the Term Weight Engine 206 utilizes interactions of a plurality of member accounts with various job profiles to learn text section-specific global weights (GWs) for various terms. For example, the Term Weight Engine 206 learns and generates a GW for the terms “software design” in a job posting “Skills” section based on a plurality of member accounts previously viewing and applying to multiple job postings that include the terms “software design” in their respective “Skills” section. The GW is thereby reflective of the member accounts' positive interactions (i.e. view & apply). Therefore, regardless if a large amount of active job postings include the terms “software design” in various sections, the GW for “software design” in a job posting “Skills” section predicts whether (or not) a member account will apply for a given job posting.

It is understood that a GW is section specific. That is, a particular term's GW can vary according to what type of text section in which it appears. For example, the Term Weight Engine learns a first GW when a term appears in a “Skills” section and learns a second GW for the same term when it appears in a “Job Title” section. It is understood that the Term Weight Engine 206 may also learn a third GW for when the same term appears in a particular text section of a user profile.

At operation 425, the Term Weight Engine 206 calculates a similarity score of the pairing as between a first user profile of a target member account and a first job posting. For example, the Term Weight Engine 206 determines a similarity (via the cosine similarity function) between one or more pairings. The Term Weight Engine 206 determines a first similarity score between a user profile of the target member account's “Skills” section and the given job posting's “Skills” section (i.e. the first pairing). The Term Weight Engine determines a second similarity score between the user profile of the target member account's “Job Description” section and the given job posting's “Skills” section (i.e. the second pairing). The Term Weight Engine determines a total similarity score based on a sum of the scored pairings with respect to their pairing weights.

At operation 430, based on identifying that the term (such as a global term) appears in the pairing as between a first user profile of a target member account and a first job posting, the Term Weight Engine 206 applies the global weight to the similarity score to generate a prediction indicating whether the target member account will apply to the first job posting. For example, the Term Weight Engine 206 identifies that the terms “software design” appears in the given job posting's “Skills” section. The Term Weight Engine applies the GW for “software design” in a job posting “Skills” section to the total similarity score to generate a prediction as to whether the target member account will apply to the given job posting.

At operation 435, the Term Weight Engine 206 determines whether to send a recommendation of the first job posting to the target member account based on the prediction. Based on the prediction meeting (or exceeding) a prediction threshold, the Term Weight Engine 206 sends a notification to the target member account. The notification, such as an e-mail message, includes a recommendation of the given job posting to the target member account.

In addition, in various embodiments, the Term Weight Engine 206 further adjusts a GW for a term in a particular section based on a learned pairing weight that includes that particular section. For example, learning the GW for the terms “software design” for appearance in a job posting “Skills” section can be further adjusted when the terms “software design” are included in a particular pairing that has a learned pairing weight that meets or exceeds an importance threshold. Stated differently, if a particular pairing (e.g. user profile “Job Description” section and job posting “Skills” section) is assigned a high pairing weight, then the Term Weight Engine 206 has learned that similarities between the particular pairing are highly predictive of whether a respective member account will apply to a given job posting. Based on the importance of the particular pairing, the Term Weight Engine 206 will further optimize the GW for the terms “software design” for appearance in a job posting “Skills” section for when the terms “software design” appear that particular pairing. Therefore, a GW can not only be section specific, but also be concurrently pairing specific.

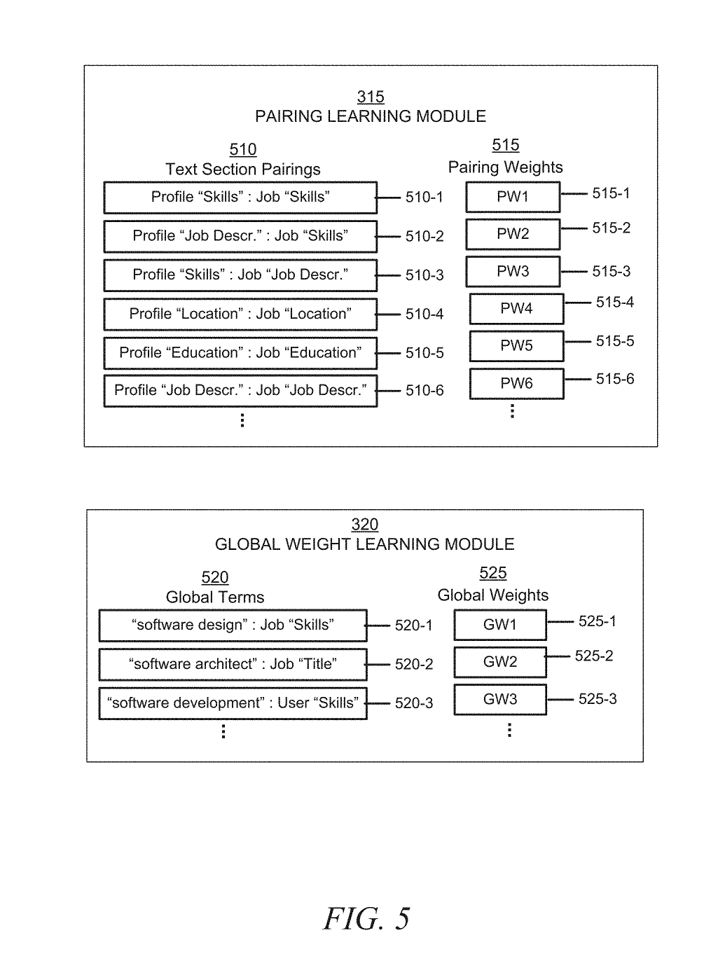

FIG. 5 is a block diagram illustrating text section pairings, pairing weights, global terms and global term weights, according to embodiments described herein.

In example embodiments, the Term Weight Engine 206 utilizes a machine learning model for predicting whether a given job posting that is actively accessible and viewable in a social network service is relevant to a member account(s) of the social network service. The Term Weight Engine 206 builds the model based on training data. The training data includes previous interactions of various member accounts with regard to various job postings. For example, such interactions comprise social network activity such as viewing a job posting, applying to a job posting, rating (e.g. “liking” a job posting), sharing a job posting with another member account that is a social network connection. The training data also includes a term(s) within a specific user profile text section and/or a term(s) in a specific job posting section.

The training data is utilized to identify relationships between how various member accounts interact (e.g. apply, view, rate) with job postings in light of text similarities between their user profile text sections and job posting's text sections. The Term Weight Engine 206 applies logistic regression algorithms to identify when text similarities between a type of user profile text section and a type of job posting text section is germane in predicting how likely a member account will apply to a job posting. The Term Weight Engine 206 further applies the logistic regression algorithms to learn pairing weight coefficients for each respective text section pairing. Each learned pairing weight coefficient reflects a priority that a particular text section pairing will be given when calculating a similarity score.

For example, FIG. 5 illustrates a listing of text section pairings 510 and a listing of corresponding pairing weights 515. The listing of text section pairings 510 includes a first pairing 510-1, a second pairing 510-2, a third pairing 510-3, a fourth pairing 510-4, a fifth pairing 510-5 and a sixth pairing 510-6 identified by the Term Weight Engine 206. The first pairing 510-1 indicates that the Term Weight Engine 206 has identified that text similarities between a member account profile's “Skills” section and a job posting's “Skills” section is predictive of whether a given member account will apply to the job posting. A first pairing weight 515-1 is associated with the first pairing 510-1. The first pairing weight 515-1 is a learned coefficient that reflects a priority of the first pairing 510-1 when calculating a similarity score between a given member account's profile and a given job posting that have text similarities between their respective “Skills” sections.

The second pairing 510-2 indicates that the Term Weight Engine 206 has also identified that text similarities between a member account profile's “Job Description” section and a job posting's “Skills” section is predictive of whether a given member account will apply to the job posting. A second pairing weight 515-2 is associated with the second pairing 510-2. The second pairing weight 515-2 is a learned coefficient that reflects a priority of the second pairing 510-2 when calculating a similarity score between a given member account's profile and a given job posting that have text similarities between their respective “Job Description” and “Skills” sections.

The third pairing 510-3 indicates that the Term Weight Engine 206 has also identified that text similarities between a member account profile's “Skills” section and a job posting's “Job Description” section is predictive of whether a given member account will apply to the job posting. A third pairing weight 515-3 is associated with the third pairing 510-3. The third pairing weight 515-3 is a learned coefficient that reflects a priority of the third pairing 510-3 when calculating a similarity score between a given member account's profile and a given job posting that have text similarities between their respective “Skills” and “Job Description” sections.

The fourth pairing 510-4 indicates that the Term Weight Engine 206 has also identified that text similarities between a member account profile's “Location” section and a job posting's “Location” section is predictive of whether a given member account will apply to the job posting. A fourth pairing weight 515-4 is associated with the fourth pairing 510-4. The fourth pairing weight 515-4 is a learned coefficient that reflects a priority of the fourth pairing 510-4 when calculating a similarity score between a given member account's profile and a given job posting that have text similarities between their respective “Location” sections.

The fifth pairing 510-5 indicates that the Term Weight Engine 206 has also identified that text similarities between a member account profile's “Education” section and a job posting's “Education” section is predictive of whether a given member account will apply to the job posting. A fifth pairing weight 515-5 is associated with the fifth pairing 510-5. The fifth pairing weight 515-5 is a learned coefficient that reflects a priority of the fifth pairing 510-5 when calculating a similarity score between a given member account's profile and a given job posting that have text similarities between their respective “Education” sections.

The sixth pairing 510-6 indicates that the Term Weight Engine 206 has also identified that text similarities between a member account profile's “Job Description” section and a job posting's “Job Description” section is predictive of whether a given member account will apply to the job posting. A sixth pairing weight 515-6 is associated with the sixth pairing 510-6. The sixth pairing weight 515-6 is a learned coefficient that reflects a priority of the sixth pairing 510-6 when calculating a similarity score between a given member account's profile and a given job posting that have text similarities between their respective “Job Description” sections.

In addition, the training data is utilized by the Term Weight Engine 206 to identify relationships between how various member accounts interact (e.g. apply, view, rate) with job postings based on the appearance of one or more terms in a particular user profile text section or a job posting text section. The Term Weight Engine 206 identifies when the appearance of a term(s) in a particular type of text section is germane in predicting how likely a member account will apply to a job posting. The Term Weight Engine applies the logistic regression algorithms to learn a global weight coefficient for a respective term's appearance in a particular type of text section. Each learned global weight coefficient reflects a priority weight that in calculating a prediction of whether a member account will apply to a job posting when the respective term is present.

For example, as illustrated in FIG. 5, a listing of global terms 520 and a listing of corresponding global weights 525. The listing of global terms 520 includes a first global term 520-1, a second global term 520-2 and a third global term 520-3 identified by the Term Weight Engine 206.

The first global term 520-1 represents that appearance of the phrase “software design” in a job posting's “Skills” section is germane in predicting whether a given member account will apply to the job posting. A first global weight 525-1 is a priority weight used by the Term Weight Engine 206 when calculating a prediction of whether a member account will apply to a job posting when “software design” is present in the job posting's “Skills” section.

The second global term 520-2 represents that appearance of the phrase “software architect” in a job posting's “Title” section is germane in predicting whether a given member account will apply to the job posting. A second global weight 525-2 is a priority weight used by the Term Weight Engine 206 when calculating a prediction of whether a member account will apply to a job posting when “software architect” is present in the job posting's “Title” section.

The third global term 520-3 represents that appearance of the phrase “software development” in a member account's profile “Skills” section is germane in predicting whether a given member account will apply to the job posting. A third global weight 525-3 is a priority weight used by the Term Weight Engine 206 when calculating a prediction of whether a member account will apply to a job posting when “software development” is present in the “Skills” section of that member account's profile.

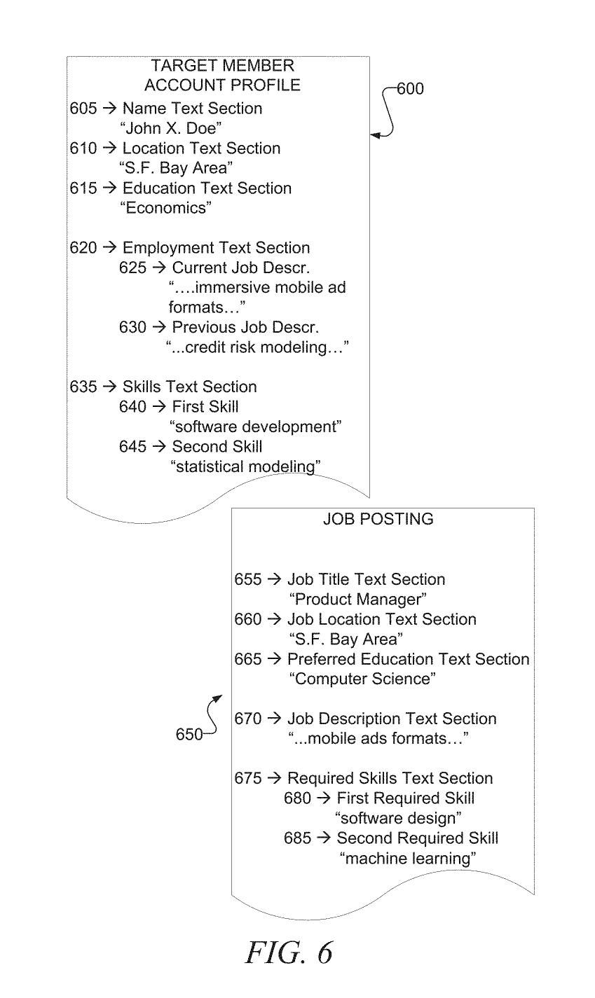

FIG. 6 is a block diagram illustrating text sections of a target member account's profile and text sections of a job posting, according to embodiments described herein.

A target member account in the social network service has a user profile 600 and a job posting 650 is accessible via the social network service as well. The user profile 600 includes various text sections 605, 610, 615, 620, 635. A name text section 605 includes text representative of the target member account's name, “John X. Doe”. A location text section 610 includes text representative of the target member account's current geographical region, “S.F. Bay Area”. An education text section 615 includes text representing academic training in “Economics”. An employment text section 620 includes text representative of a current job description 625 and a previous job description 630. A current job description 625 includes a phrase of “ . . . immersive mobile ad formats . . . ” and the previous job description includes a phrase of “credit risk modelling . . . .”

A job posting 650 published in the social network service has various text sections 655, 660, 665, 670, 675, 680, 685. A job title text section 655 includes a job title of “Product Manager”. A job location text section 660 includes text indicating the job is located in the “S.F. Bay Area.” A preferred education text section 665 includes text indicating that the preferred education of an applicant for the job is academic training in “Computer Science”. The job description text section includes a phrase of “ . . . mobile ads formats . . . .” The required skills text section 756 includes a first required skill 680 of “software design” and a second required skill 685 of “machine learning”.

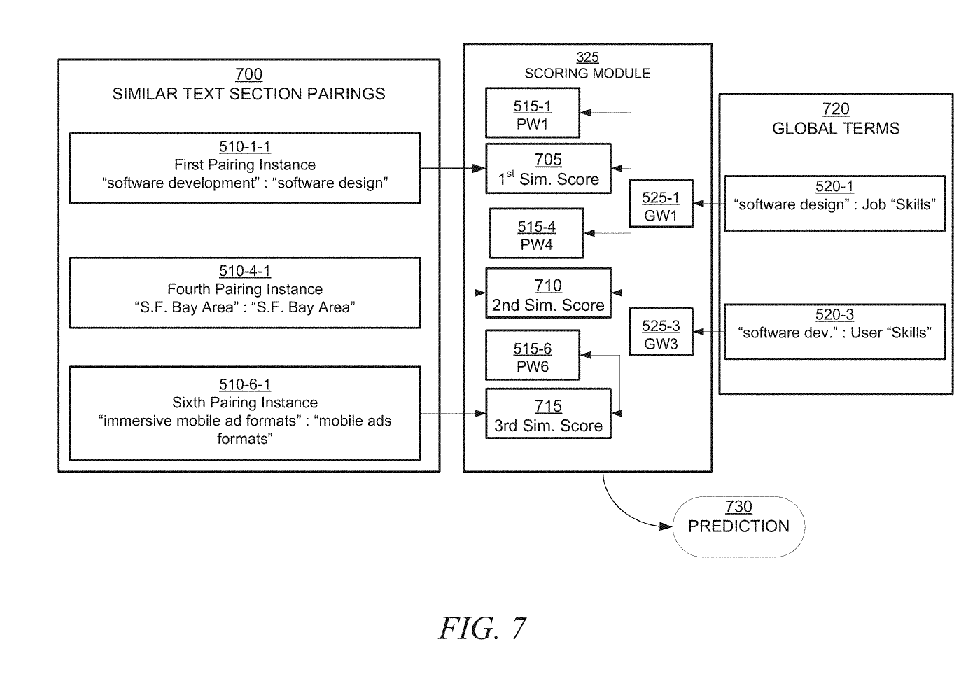

FIG. 7 is a block diagram illustrating generating a prediction of whether a target member account will apply to given job posting, according to embodiments described herein.

The Term Weight Engine 206 compares the text sections 605, 610, 615, 620, 635, 655, 660, 665, 670, 675 of the target member account's profile 600 and the job posting 650 in order to identify similar text section pairings 700. For example, the Term Weight Engine 206 applies a cosine similarity function in order to identify similar text sections. The Term Weight Engine 206 identifies a first pairing instance 510-1-1, where the target member account's profile 600 includes a Skill of “software development” and the job posting includes a Skill of “software design.” The scoring module 325 of the Term Weight Engine 206 calculates a first similarity score 705 for the first pairing instance 510-1-1.

The Term Weight Engine 206 identifies a fourth pairing instance 510-4-1, where both the target member account's profile 600 and the job posting 650 include a location of “S.F. Bay Area.” The scoring module 325 of the Term Weight Engine 206 calculates a second similarity score 710 for the fourth pairing instance 510-4-1. The Term Weight Engine 206 identifies a sixth pairing instance 510-6-1, where the target member account's profile 600 includes a job description with the phrase of“immersive mobile ad formats” and the job posting 650 includes a job description with the phrase of “mobile ads formats.” The scoring module 325 of the Term Weight Engine 206 calculates a third similarity score 715 for the sixth pairing instance 510-6-1. The scoring module 325 generates a prediction 730 based at least on the first similarity score 705, the first pairing weight 515-1, the second similarity score 710, the fourth pairing weight 515-4, the third similarity score 715 and the sixth pairing weight 515-6.

The Term Weight Engine 206 further identifies any appearances of the global terms 520 in the target member account's profile 600 and the job posting 650. The Term Weight Engine 206 identifies that the job posting 650 includes the global term 520-1 of“software design” as a Skill. Based on the global term 520-1 being present in the first pairing instance 510-1-1, the prediction 730 generated by the scoring module 325 will be further based on the first global weight 525-1. The Term Weight Engine 206 identifies that the target member account's profile 600 includes the global term 520-3 of“software development” as a Skill. Based on the global term 520-3 also being present in the first pairing instance 510-1-1, the prediction 730 generated by the scoring module 325 will be further based on the third global weight 525-1. The prediction 730 represents how likely the target member account will apply to the job posting 650.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

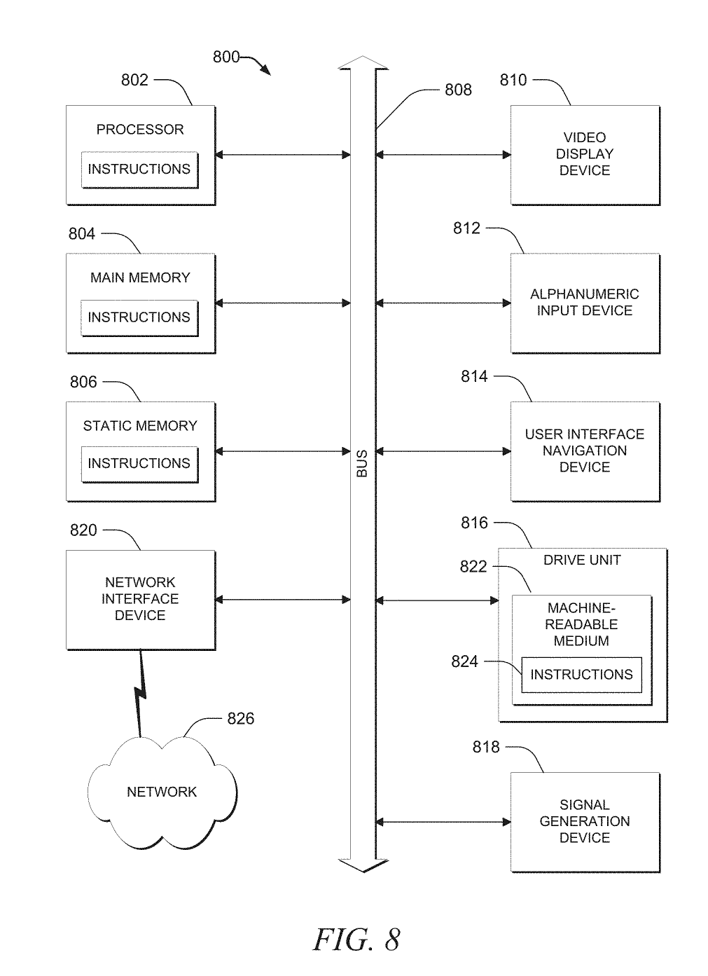

FIG. 8 is a block diagram of a machine in the example form of a computer system 500 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 800 includes a processor 802 (e.g., a central processing unit (CPU), a graphics processing unit (GPU) or both), a main memory 804, and a static memory 806, which communicate with each other via a bus 808. Computer system 800 may further include a video display device 810 (e.g., a liquid crystal display (LCD) or a cathode ray tube (CRT)). Computer system 800 also includes an alphanumeric input device 812 (e.g., a keyboard), a user interface (UI) navigation device 814 (e.g., a mouse or touch sensitive display), a disk drive unit 816, a signal generation device 818 (e.g., a speaker) and a network interface device 820.

Disk drive unit 816 includes a machine-readable medium 822 on which is stored one or more sets of instructions and data structures (e.g., software) 824 embodying or utilized by any one or more of the methodologies or functions described herein. Instructions 824 may also reside, completely or at least partially, within main memory 804, within static memory 806, and/or within processor 802 during execution thereof by computer system 800, main memory 804 and processor 802 also constituting machine-readable media.

While machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 824 may further be transmitted or received over a communications network 826 using a transmission medium. Instructions 824 may be transmitted using network interface device 820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer system comprising:
a processor;
a memory device holding an instruction set executable on the processor to cause the computer system to perform operations comprising:
defining a pairing comprising a user profile text section paired with a job posting text section;
learning a pairing weight indicating an extent that a similarity of text in the pairing predicts a relevance of a respective job posting to a given user profile;
learning a global weight for at least one term;
calculating a similarity score, based at least on the pairing weight, of the pairing as between a first user profile of a target member account and a first job posting;
based on identifying that the term appears in the pairing as between the first user profile of the target member account and the first job posting, applying the global weight to the similarity score to generate a prediction indicating whether the target member account will apply to the first job posting; and
determining whether to send a recommendation of the first job posting to the target member account based on the prediction.

2. The computer system of claim 1, wherein learning the global weight for the at least one term comprises:
learning a global weight for appearance of the at least one term in a particular job posting section based on previous interactions of a plurality of member accounts, of a social network service, with respective job postings that include the at least one term in the particular job posting text section.

3. The computer system of claim 2, wherein learning a global weight for appearance of the at least one term in a particular job posting section based on previous interactions of a plurality of member accounts with respective job postings that include the at least one term in the particular job posting text section comprises:
learning the global weight based at least on:
a first user account applying to a first job posting comprising the particular job posting text section that includes the at least one term;
a second user account viewing a second job posting comprising the particular job posting text section that includes the at least one term; and
a third user account rating a third job posting comprising the particular job posting text section that includes the at least one term.

4. The computer system of claim 1, wherein learning the global weight for the at least one term comprises:
learning a global weight of the at least one term in a particular user profile section based on previous interactions of a plurality of member accounts, of a social network service, with respective job postings, wherein the plurality of member accounts have corresponding user profiles that include the at least one term in the particular user profile text section.

5. The computer system of claim 4, wherein learning a global weight of the at least one term in a particular user profile section based on previous interactions of a plurality of member accounts with respective job postings comprises:
learning the global weight based at least on:
a first user account applying to a first job posting, wherein the first user account comprises a first user profile with the particular user profile text section that includes the at least one term;
a second user account viewing to a second job posting, wherein the second user account comprises a second user profile with the particular user profile text section that includes the at least one term; and
a third user account rating a third job posting, wherein the third user account comprises a third user profile with the particular user profile text section that includes the at least one term.

6. The computer system of claim 1, wherein calculating a similarity score of the pairing as between a first user profile of a target member account and a first job posting comprises:
applying a cosine similarity function to the user profile text section of the first user profile and the job posting text section of the first job posting; and
calculating the similarity score based at least on a result of the cosine similarity function.

7. The computer system of claim 1, wherein defining a pairing comprising a user profile text section paired with a job posting text section comprises:
defining a first pairing as a user profile Skills text section and a job posting Skills text section.

8. A computer-implemented method, comprising:
defining a pairing comprising a user profile text section paired with a job posting text section;
learning a pairing weight indicating an extent that a similarity of text in the pairing predicts a relevance of a respective job posting to a given user profile;
learning a global weight for at least one term;
calculating, using at least one processor of a machine, a similarity score, based at least in part on the pairing weight, of the pairing as between a first user profile of a target member account and a first job posting;
based on identifying the term appears in the pairing as between the first user profile of the target member account and the first job posting, applying the global weight to the similarity score to generate a prediction indicating whether the target member account will apply to the first job posting; and
determining whether to send a recommendation of the first job posting to the target member account based on the prediction.

9. The computer-implemented method of claim 8, wherein learning the global weight for the at least one term comprises:
learning a global weight for appearance of the at least one term in a particular job posting section based on previous interactions of a plurality of member accounts, of a social network service, with respective job postings that include the at least one term in the particular job posting text section.

10. The computer-implemented method of claim 9, wherein learning a global weight for appearance of the at least one term in a particular job posting section based on previous interactions of a plurality of member accounts with respective job postings that include the at least one term in the particular job posting text section comprises:
learning the global weight based at least on:
a first user account applying to a first job posting comprising the particular job posting text section that includes the at least one term;
a second user account viewing to a second job posting comprising the particular job posting text section that includes the at least one term; and
a third user account rating a third job posting comprising the particular job posting text section that includes the at least one term.

11. The computer-implemented method of claim 8, wherein learning the global weight for the at least one term comprises:
learning a global weight of the at least one term in a particular user profile section based on previous interactions of a plurality of member accounts, of a social network service, with respective job postings, wherein the plurality of member accounts have corresponding user profiles that include the at least one term in the particular user profile text section.

12. The computer-implemented method of claim 11, wherein learning a global weight of the at least one term in a particular user profile section based on previous interactions of a plurality of member accounts with respective job postings comprises:
learning the global weight based at least on:
a first user account applying to a first job posting, wherein the first user account comprises a first user profile with the particular user profile text section that includes the at least one term;
a second user account viewing to a second job posting, wherein the second user account comprises a second user profile with the particular user profile text section that includes the at least one term; and
a third user account rating a third job posting, wherein the third user account comprises a third user profile with the particular user profile text section that includes the at least one term.

13. The computer-implemented method of claim 8, wherein calculating a similarity score of the pairing as between a first user profile of a target member account and a first job posting comprises:
applying a cosine similarity function to the user profile text section of the first user profile and the job posting text section of the first job posting; and
calculating the similarity score based at least on a result of the cosine similarity function.

14. The computer-implemented method of claim 8, wherein defining a pairing comprising a user profile text section paired with a job posting text section comprises:
defining a first pairing as a user profile Skills text section and a job posting Skills text section.

15. A non-transitory computer-readable medium storing executable instructions thereon, which, when executed by a processor, cause the processor to perform operations including:
defining a pairing comprising a user profile text section paired with a job posting text section,
learning a pairing weight indicating an extent that a similarity of text in the pairing predicts a relevance of a respective job posting to a given user profile;
learning a global weight for at least one term;
calculating a similarity score, based at least in part on the pairing weight, of the pairing as between a first user profile of a target member account and a first job posting;
based on identifying the term appears in the pairing as between the first user profile of the target member account and the first job posting, applying the global weight to the similarity score to generate a prediction indicating whether the target member account will apply to the first job posting; and
determining whether to send a recommendation of the first job posting to the target member account based on the prediction.

16. The non-transitory computer-readable medium of claim 15, wherein learning the global weight for the at least one term comprises:
learning a global weight for appearance of the at least one term in a particular job posting section based on previous interactions of a plurality of member accounts, of a social network service, with respective job postings that include the at least one term in the particular job posting text section.

17. The non-transitory computer-readable medium of claim 16, wherein learning a global weight for appearance of the at least one term in a particular job posting section based on previous interactions of a plurality of member accounts with respective job postings that include the at least one term in the particular job posting text section comprises:
learning the global weight based at least on:
a first user account applying to a first job posting comprising the particular job posting text section that includes the at least one term;
a second user account viewing to a second job posting comprising the particular job posting text section that includes the at least one term; and
a third user account rating a third job posting comprising the particular job posting text section that includes the at least one term.

18. The non-transitory computer-readable medium of claim 15, wherein learning the global weight for the at least one term comprises:
learning a global weight of the at least one term in a particular user profile section based on previous interactions of a plurality of member accounts, of a social network service, with respective job postings, wherein the plurality of member accounts have corresponding user profiles that include the at least one term in the particular user profile text section.

19. The non-transitory computer-readable medium of claim 18, wherein learning a global weight of the at least one term in a particular user profile section based on previous interactions of a plurality of member accounts with respective job postings comprises:
learning the global weight based at least on:
a first user account applying to a first job posting, wherein the first user account comprises a first user profile with the particular user profile text section that includes the at least one term;
a second user account viewing to a second job posting, wherein the second user account comprises a second user profile with the particular user profile text section that includes the at least one term; and
a third user account rating a third job posting, wherein the third user account comprises a third user profile with the particular user profile text section that includes the at least one term.

20. The non-transitory computer-readable medium of claim 15, wherein calculating a similarity score of the first pairing as between a first user profile of a target member account and a first job posting comprises:
applying a cosine similarity function to the user profile text section of the first user profile and the job posting text section of the first job posting; and
calculating the similarity score based at least on a result of the cosine similarity function.
